(19) United States
(12) Patent Application Publication
(10) Pub. No.: US 2016/0185009 A1
(43) Pub. Date: Jun. 30, 2016

(54) ADDITIVE MANUFACTURING OF COMPOSITE MOLDS

(71) Applicant: SMITH INTERNATIONAL, INC., Houston, TX (US)

(72) Inventors: Madapusi K. Keshavan, The Woodlands, TX (US); Srinand S. Karuppoor, Sugar Land, TX (US)

(21) Appl. No.: 14/952,187

(22) Filed: Nov. 25, 2015

Related U.S. Application Data
(60) Provisional application No. 62/097,381, filed on Dec. 29, 2014.

(51) Int. Cl. B28B 1/00; B28B 7/34

(52) U.S. Cl. CPC B28B 1/001; B28B 7/34; B28B 7/346; B33Y 10/00

(57) ABSTRACT

A method of forming a mold used to manufacture downhole tools includes depositing successive layers of a material mixture and an adhesive using an automated layering device according to a computer aided pattern, the material mixture including a first composition and a second composition, the first composition having at least a different shape, size, or chemical composition than the second composition, at least one of the first composition or the second composition being granulated.

### CROSS REFERENCE TO RELATED APPLICATION

This application claims the benefit of and priority to U.S. Provisional Application 62/097,381 filed on Dec. 29, 2014, the entirety of which is incorporated herein by reference.

### BACKGROUND

A variety of components are utilized for drilling earth formations, and to improve drilling efficiency, the components are often designed and tailored for the specific type of earth formation that is to be encountered. For example, after designing a matrix body drill bit, a mold is often formed to serve as a template during the fabrication of the component.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

Some embodiments of the present disclosure relate to a method of forming a mold used to manufacture downhole tools. The method includes depositing successive layers of a material mixture and an adhesive using an automated layering device according to a computer aided pattern. The material mixture includes a first composition and a second composition, the first composition having at least a different shape, size, or chemical composition than the second composition, and at least one of the first composition or the second composition is granulated.

Some embodiments disclosed herein relate to a method of forming for components used in downhole tools using a mold. The method includes depositing successive layers of a material composition including a granulated powder using an automated layering device based on a computer aided design, binding a portion of the successive layers of the material composition together to form the mold, and forming the component using the mold.

Some embodiments disclosed herein relate to a mold used to manufacture downhole tools. The mold includes a material mixture and an adhesive formed using an automated layering device according to a computer aided pattern. The material mixture includes a first composition and a second composition, the first composition having at least a different shape, size, or chemical composition than the second composition, and at least one of the first composition or the second composition is granulated.

Other aspects and advantages of the claimed subject matter will be apparent from the following description and the appended claims.

### BRIEF DESCRIPTION OF DRAWINGS

FIG. 1 is a flow chart of a method of forming a component or mold according to embodiments of the present disclosure.

FIG. 2 is a schematic of methods for forming a component according to embodiments of the present disclosure.

FIG. 3 is an embodiment for forming a mold using a layering device.

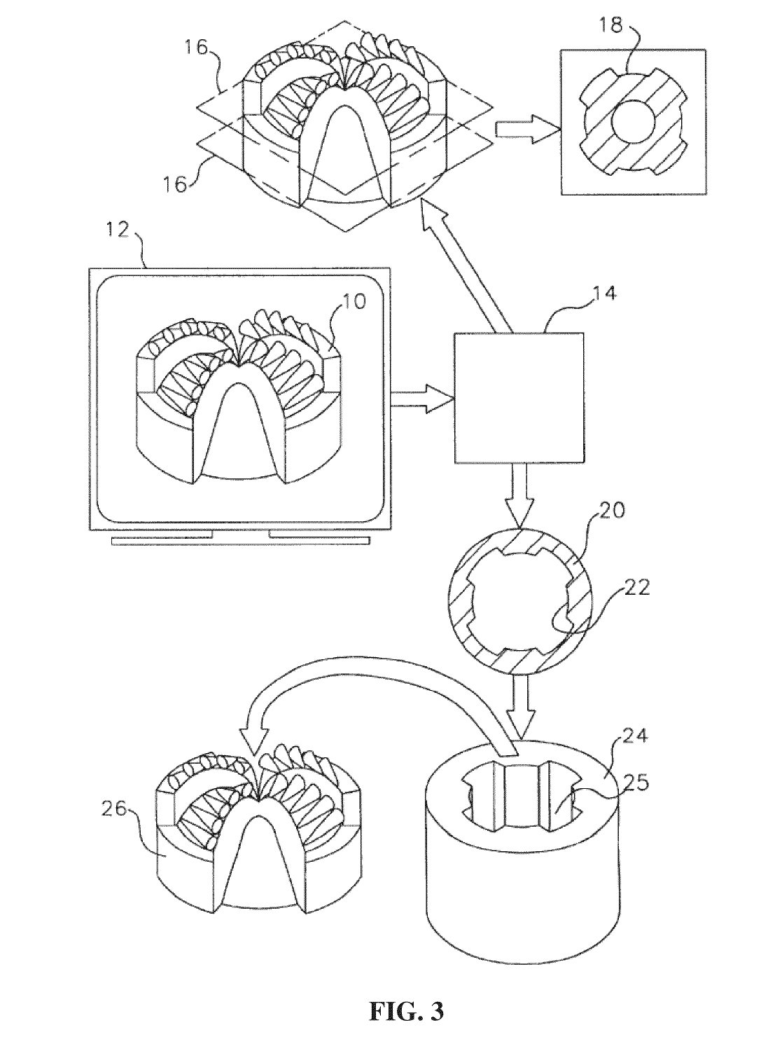

FIG. 4 shows a cross sectional view of a mold assembly according to embodiments of the present disclosure.

### DETAILED DESCRIPTION

In some embodiments disclosed herein relate generally to molds that are fabricated using additive manufacturing, such as 3D printing, robot casting, or simultaneous casting, which then are used for making components utilized in drilling operations. Some embodiments relate to fabrication of components for use as or with downhole tools using such types of additive manufacturing. In some embodiments, an earth formation to be drilled may be analyzed to determine the optimum (or an improved) design for the particular component. Based on this analysis, a geometry is designed in three dimensions using a computer aided design (CAD) system. The three dimensional design is commonly referred to as a solid model. To generate a design, a designer may generate a new design or the designer may make modifications in angles, curvatures, and dimensions of an existing design to adapt the design for drilling a specific earth formation. A design of a mold is generated based on the CAD design, e.g., the CAD system may generate a geometry design of a mold, for producing the component. In some embodiments, the mold or component is designed directly within the CAD system. In some embodiments, a mold is designed in discrete sections which interconnect to form the mold.

According to embodiments of the present disclosure, additive manufacturing may be used to form a mold for fabricating components used in drilling operations, or to form the components themselves. Such additive manufacturing techniques allow for the part (whether it is the mold or component) to be formed by depositing sequential or successive layers of selected material in designated regions. In some embodiments, a method of manufacturing such a mold includes depositing a first layer on a substrate and depositing multiple sequential layers at least partially adjacent the first layer. In one or more embodiments, at least a portion of each of the multiple sequential layers are made of the same material mixture or composition as adjacent portions of adjacent layers, but the present disclosure is not so limited and may include adjacent layers with different material mixtures and/or compositions.

A binder or adhesive may be used to bind the first layer and multiple sequential layers together to form the mold or component part. The binder or adhesive may simply act as an adhesive or it may chemically react with the materials of the first layer to bind them together. In some embodiments, the binder or adhesive may be mixed within the material composition prior to being deposited by the layering device, the binder or adhesive may be applied through a separate nozzle of the layering device and simultaneously applied with the material composition, or a layer of the binder or adhesive may be deposited between layers of the material composition. In some embodiments, when applied separately from the material composition, the binder or adhesive may be selectively placed at certain areas of the deposited material composition by the layering device. The selective placement of the binder or adhesive may serve to define the final morphology of the formed component/mold, as in some instances only areas of the material composition in substantially close contact with the binder or adhesive will be bound together to form the component.

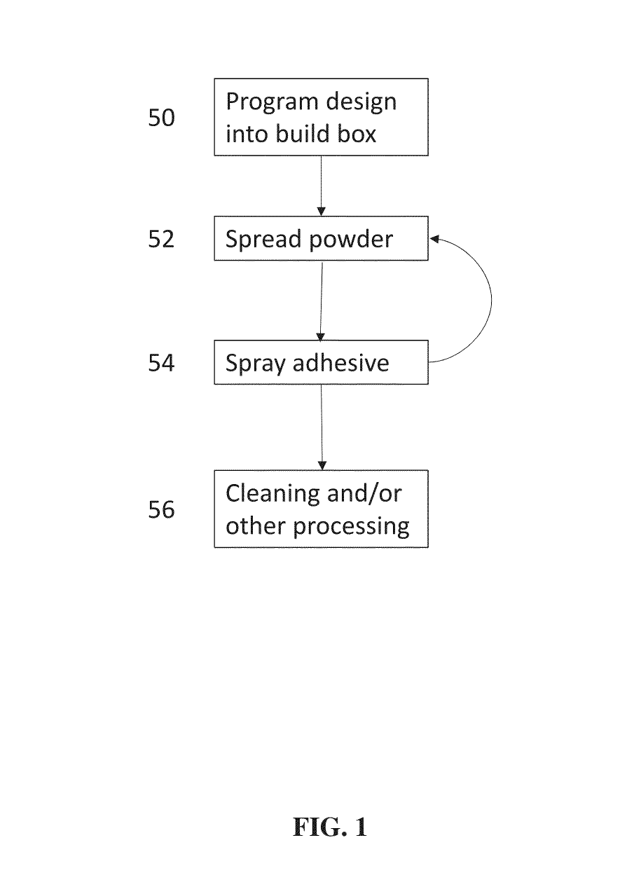

As shown in FIG. 1, in one or more embodiments, an additive manufacturing process for a mold or component may begin by taking a CAD model of a mold or component and determining its placement within the “build box,” also known as the substrate or area where the material deposition takes place, of the additive manufacturing instrument using a computer aided interface 40. In some embodiments, multiple CAD models of molds or components may be arrayed within the build box to maximize the efficiency of the additive manufacturing process by completing multiple molds or components during the same deposition session. The CAD model may be analyzed to draw detailed information for each layer that will be deposited, thereby allowing the additive manufacturing machine to be programmed to form each layer.

The additive manufacturing process may then proceed with the deposition of a layer of the material composition throughout the build box of the additive manufacturing instrument 52. A binder or adhesive is then applied to the specific areas of the build box where the component or mold will be according to the placement of the CAD models in the build box 54. For example, the computer aided pattern based on the placement of the models in the build box dictates where the binder or adhesive is applied. In some embodiments, the application of the adhesive or binder to the specific areas of the build box may be accomplished by spraying the adhesive or binder. For example, using a technology similar to ink-jet printing, a binder material is sprayed on and joins particles in the locations of the build box where the object is to be formed. After the application of the adhesive or binder to a layer of particles, another layer of material composition may be spread across the build box of the additive manufacturing instrument 52 and then another pass of a binder or adhesive may be applied on the designated areas of the new material composition layer to form a second layer of the mold or component 54. The layer of particles is spread across the build box using known methods, e.g., a hopper may feed the powder to an arm which may spread the powder as it travels across the box. The process of layering the material composition throughout the build box following by applying a binder or adhesive to the designated areas may be repeated until all the layers required to form the mold or component are deposited. The molds or components may then be harvested or removed from the build box for further processing or as finished molds or components. The support gained from the powder bed (i.e., the regions of powder that do not include the adhesive or binder) allows overhangs, undercuts, and internal volumes to be created as long as there is a hole or pathway for the loose powder to escape.

Further processing may include the cleaning of the mold or component to remove any material composition that is loosely connected or otherwise not bound to the mold or component 56. In some embodiments, further processing may include heating to aid in the curing and consolidation of the mold or component into a solid and suitably bound together mass capable of its intended function. In some embodiments, the mold or component formed by the additive manufacturing process may be infiltrated to further strengthen the bond of the material composition. For example, when a component is being formed, tungsten powder may be infiltrated with a copper based alloy to strengthen the component.

The additive manufacturing assembly described herein may be any suitable device capable of fabricating a part or mold using a CAD or other model as a template or guide. Suitable commercially available additive manufacturing assemblies capable of assembling parts or molds as described in FIG. 1 include S-MAX, S-PRINT, M-PRINT, M-FLEX, and/or X1-LAB, which are available from The ExOne Company, located in North Huntingdon, Pa.

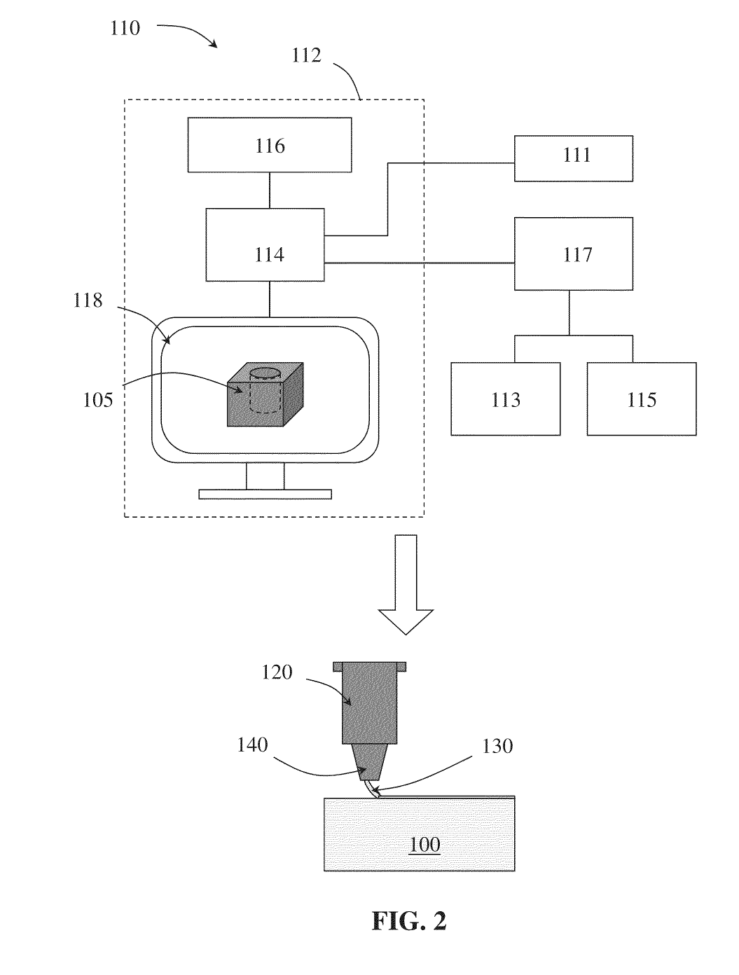

FIG. 2 shows a schematic view of a method for making a part 100 using additive manufacturing, according to one or more embodiments. As used with reference to FIG. 2 and throughout the application, the term “part” is broadly used to include the piece or part being made by additive manufacturing. As discussed above, the additive manufacturing process may be used to make a mold (in which a tool or tool component is made) or a tool component, and the term part includes both a mold or a tool or tool component. As discussed above, additive manufacturing allows the part 100 to be created by serially adding small quantities of material under computer control to an evolving geometry. The method includes designing the part 100 using a CAD system 110. When the part 100 is a mold in which a tool or tool component is made, the design may involve design of the mold or design of the tool or tool component being made in the mold. The CAD system 110 may be or include any software of a computer aided design capable of providing a geometry or digital design 105 for the part 100 in three dimensions. The digital design 105 may be used as a template or guide by a layering device 120 to fabricate the part 100. As shown, a flowable form of the material 130 used to form the part 100 is passed through at least one nozzle 140 of the layering device 120 and deposited layer by layer to create the part 100, as designed by the CAD system 110. However, as described above, other layering devices, including ones in which layers of material and layers of adhesive or binder are repeatedly added on top of each other, may also be used.

The CAD system 110 may include one or more computers 112 that may include one or more central processing units 114, one or more input and/or output devices or keyboards 116, and one or more monitors 118 on which a software application may be executed. The computer 112 may also include memory 111. The input and/or output devices may be used for, among other purposes, universal access and voice recognition or commanding. The monitor 118 may be touch-sensitive to operate as an input device as well as a display device.

The computer 112 may interface with one or more databases 113, support computers or processors 115, other databases and/or other processors, or the Internet via the network interface 117. It should be understood that the term “interface” refers to any possible external interfaces, wired or wireless. It should also be understood that the database 113, processor 115, and/or other databases and/or other processors are not limited to interfacing with the computer 112 using the network interface 117 and may interface with the computer 112 in any way sufficient to create a communications path between the computer 112 and database 113, the processor 115, and/or other databases and/or other processors. For example, the database 113 may interface with the computer 112 via a USB interface while the processor 115 may interface via some other high-speed data bus without using the network interface 117. The computer 112, the processor 115, and other processors may be integrated into a multiprocessor distributed system.

Although the computer 112 is shown as a platform on which the methods discussed and described herein may be performed, the methods discussed and described herein may be performed on any platform, for example, on any device that has computing capability. For example, the computing capability may include the capability to access communications bus protocols such that the user may interact with the many and varied computers 112, processors 115, and/or other databases and processors that may be distributed or otherwise assembled. These devices may include, but are not limited to, supercomputers, arrayed server networks, arrayed memory networks, arrayed computer networks, distributed server networks, distributed memory networks, distributed computer networks, desktop personal computers (PCs), tablet PCs, hand held PCs, laptops, cellular phones, hand held music players, or any other device or system having computing capabilities.

Programs or software may be stored in the memory 111, and the central processing unit 114 may work in concert with the memory 111, the input device 116, and the output device 118 to perform tasks for the user. The memory 111 may include, but is not limited to, any number and combination of memory devices that are currently available or may become available in the art. For example, the memory devices may include, but are not limited to, the database 113, other databases and/or processors, hard drives, disk drives, random access memory, read memory, electronically erasable programmable read memory, flash memory, thumb drive memory, and any other memory device. Those skilled in the art are familiar with the many variations that may be employed using memory devices, and no limitations should be imposed on the embodiments herein due to memory device configurations and/or algorithm prosecution techniques. The memory 111 may store an operating system and/or any software of the computer assisted device capable of providing the digital design 105. The operating system may facilitate, control, and execute the software using a central processing unit 114. Any available operating system may be used in this manner. The central processing unit 114 may execute the software from a user requests or automatically.

Referring still to FIG. 2, the layering device 120 may be or include any device capable of fabricating the part 100 using the digital design 105 as a template or guide. The layering device 120 may fabricate the part 100 from the digital design 105 of the CAD system 110 in one or more processes, for example, by fabricating separate pieces of a part and then assembling the separate pieces together to form the part. Any suitable layering device 120 may be used. In addition to those described above, other suitable commercially available layering devices 120 include, but are not limited to, PROJET 1000, PROJET 1500, PROJET SD 3500, PROJET HD 3500, PROJET HD 3500PLUS, PROJET 3500 HDMAX, PROJET CP 3500, PROJET CPX 3500, PROJET CPX 3500PLUS, PROJET 3500 CPXMAX, PROJET 7000, PROJET 6000, PROJET 5000, PROJET DP 3500, PROJET MP 3500, ZPRINTER 150, ZPRINTER 250, ZPRINTER 350, ZPRINTER 450, ZPRINTER 650, and/or ZPRINTER 850, which are available from 3D Systems Corporation, located in Columbia, S.C. However, there are numerous commercially available devices from this and other manufactures that can also be used in additive manufacturing.

As described above, the material 130 used to form the part 100 may be flowed through the nozzle 140 of the layering device 120 in sequential layers to build the geometry of the digital design 105. However, different forms of material may be deposited using various types of layering devices to build the geometry of the digital design 105. For example, material deposition by a layering device may include spraying of gels, liquids, or slurries; printing of gels, slurries, or solids; spreading of solids or gels; fusing of liquids or solids; melting of solids; and solidification of liquids using a wide range of techniques. The layering device 120 may deposit one or more second or subsequent layers having dimensions corresponding to the dimensions of the adjacent and previously deposited layer, such that the cross sectional shape of the finished part is uniform along the height of the component. In other embodiments, a layering device may deposit one or more second or subsequent layers having dimensions that are different from the dimensions of the adjacent and previously deposited layer, such that the dimensions and/or the cross sectional shape of the finished component may vary along its height.

A mold (or component) made from additive manufacturing processes according to embodiments of the present disclosure may be made by depositing multiple layers to build the mold (or component) geometry, each layer made of or including one or more ceramic composite materials, graphite, thermally insulating materials, and/or low resistance metals to form one or more different regions of the mold (or component). The minimum thickness of the layers is limited by the particle size of the material that is being layered, with the minimum layer thickness being equal to or greater than the diameter of the particular material being layered. For example, in some embodiments, each layer may have a thickness ranging from 0.0003 to 0.02 inches (e.g., 0.003 to 0.020 inches). The number of distinct layers may vary, for example, from a lower limit of less than about 100, 200, 500, or 1,000 to an upper limit of 100, 200, 500, greater than 500, greater than 1,000, greater than 2,000, greater than 5,000, greater than 10,000, or greater than 100,000, where any lower limit may be used in combination with any upper layer, depending on the size of particles being deposited and the size of the mold being made. However, any layer thickness and any suitable number of layers may be used.

In some embodiments, multiple types of material (for example, materials having a difference in shape, size, or chemical composition) may be applied as a single layer by multiple passes of a layering device. For example, a first composition (having a first shape, size, and/or chemical composition) may be deposited by a layering device in a first region of a layer, and a second composition (having a second shape, size, and/or chemical composition) may be deposited by a separate pass of the layering device in a second region of the layer, such that the deposited layer has at least two distinct regions formed of the first composition and the second composition. In other embodiments, a material mixture of a first composition and second composition (the first composition having at least a different shape, size, or chemical composition than the second composition) may be deposited in a single pass of a layering device, or may be deposited sequentially in two passes of a layering device. For example, a layering device may have two or more nozzles, where each nozzle may deposit a different material in a different region of the layer during a single pass. In another example, a layering device may have two or more nozzles, where each nozzle may deposit a different material simultaneously during a pass to form a layer of composite material, e.g., a combination of ceramic material and an adhesive or an organic binder. In other embodiments, a material mixture of a first composition and a second composition may be deposited homogenously throughout a build box and an adhesive or binder may be applied in the areas of the deposited layer that are intended to form the mold or component.

According to embodiments of the present disclosure, a method of manufacturing a component used in downhole tools or a component used for forming downhole tools (e.g., a mold) includes depositing a first layer of a material mixture on a substrate, the material mixture including a first composition and a second composition, the first composition having at least a different shape, size, or chemical composition than the second composition, and depositing multiple successive layers at least partially adjacent the first layer. The successive layers may include a material mixture that is the same as that used in the deposition of the first layer or at least one of the successive layers may include a substantially different material mixture. As used herein, a substrate may refer to a platform or base that is separate from but supports the mold as it is manufactured, or a substrate may refer to any layer of the mold that has a second or subsequent layer deposited thereon, depending on the stage of manufacture. For example, manufacturing a mold may include depositing a first layer on a substrate or base that is separate from the component, and the first layer may then be the substrate for a second or subsequent layer deposited thereon.

The first and second materials may be any suitable materials for the desired end use. For example, in making a mold, the first and second materials may be selected so that the mod does not have a reaction with the matrix material (e.g., tungsten carbide) and infiltrant or binder (e.g., copper, nickel, iron, or cobalt based alloy) used during infiltration. In some embodiments, the first and second materials may be selected so that they do not have a phase change during heating or cooling that would be expected when using the mold or tool and would not have an abrupt change in thermal expansion as a function of temperature. In some embodiments, the first and second materials may have a low thermal conductivity to help dissipate heat and have a high melting point (e.g., greater than about 800° C., greater than about 1000° C., greater than about 1500° C., or greater than about ° C.). In some embodiments, the first and second materials may be selected to have a high tolerance and surface finish, e.g., within 0.01 inches, within 0.005 inches, or within 0.002 inches. In some embodiments, at least one of the first composition and second composition may include powdered materials. Powdered materials in embodiments of this disclosure may include carbonaceous materials, including amorphous carbon, activated carbon, or flake graphite, with a degree of crystallinity from about 0-100%, or from about 0-75%, or from about 0-50%, or from about 0-25%. Further, in some embodiments, the powdered materials may include metal oxides, metal carbides, metal borides, metal nitrides, or metal silicates (where metal includes metals and semi-metals, such as silicon). In some embodiments, the powdered materials may include metals such as silicon, titanium, tantalum, molybdenum, or tungsten. In some embodiments, the powdered materials may include silicon dioxide (silica), zirconium silicate (zircon), silicon carbide, aluminum nitride, amorphous carbon, or graphite. However, any suitable materials can be used.

In general, the particle size of the powdered materials may be from about 10 nm to about 400 μm (e.g., the particles may have a diameter or longest dimension within this range). In some embodiments, the particle size of the powdered materials may be from about 1 μm to about 200 μm. In some embodiments, the particle size of the powdered materials may be at least about 50 μm, e.g., from about 50 μm to about 200 μm. In some embodiments, the particle size of the powdered materials may be from about 50 μm to about 100 μm. In some embodiments, the first composition and the second composition may each be independently selected from silicon carbide, aluminum nitride, silica, zircon, amorphous carbon, or flake graphite. In one or more embodiments, the second composition may be coated on the first composition to form a material mixture. As used herein, the term coating could include a continuous coating of one material on the other material, a plurality of particles affixed to and surrounding another material, or a plurality of particles reacted to and surrounding a surface of another material. In one or more embodiments, at least one of the powdered materials may have a melting or sublimation temperature above about 2000° C. In more particular embodiments, at least one of the powdered materials may have a melting or sublimation temperature from about 2000° C. to 5000° C. or from about 3000° C. to 5000° C.

In some embodiments, at least one of the first composition and the second composition may include powdered materials that are granulated prior to their deposition and the first composition could be granulated with the second composition prior to deposition. The granulated powders may be substantially spherical and possess diameters as described above (e.g., about 10 nm to about 400 μm, about 1 μm to about 200 μm, about 50 μm to about 100 μm, etc.). For example, in some embodiments, granulated powders may be formed by the granulation of a single material, while in other embodiments, granulated powders may be formed by the granulation of at least two different materials (having a difference in at least one of shape, size, or chemical composition). The term “material mixture” as used herein may be a mixture formed by the granulation of at least two different materials. During the granulation of at least two different materials, the materials may form a substantially homogenous granule. In other embodiments, one material may be confined substantially to the interior of a granule while the other material may be substantially on the exterior of the granule to form a granule with a core-shell (e.g., the shell particles may be agglomerated on the core particle forming a coating of the shell particles). A core-shell granule may be created by granulating one powdered material first to create a first granule and then granulating the first granule with another powdered material to create the final core-shell granule. However, in some embodiments, a core-shell granule may result from the direct granulation of at least two powdered materials with differing particle sizes. In some embodiments, the core of the granule may substantially include the powdered materials with larger particle size and the exterior of the granule may include the powdered materials with smaller particle size, while in some embodiments the opposite may also occur. In embodiments using granulated powders, the particle size of the powders making up the granule may be as small as about 10 nanometers and may be smaller than 10 μm. For example, an amorphous carbon and graphite (each having a particle size of less than 10 μm) may be granulated to form a spherical composite particle having a diameter of about 50 μm. In such an embodiment, the spherical composite particle may include a core-shell structure where either amorphous carbon or graphite is the core and the other of amorphous carbon or graphite is the shell. In other embodiments, graphite and/or amorphous carbon may be granulated with silica, zircon, and/or other oxides to form a granulated spherical particle having a diameter of about 50 μm. In such an embodiment, the spherical composite particle may include a core-shell structure where either the oxide material(s) is the core and the carbon material(s) is the shell (and in some embodiments, the oxide material(s) may be the shell and the carbon material(s) may be the core). In addition, by granulating the one or more compositions, desired particle sizes and shapes may be achieved.

In some embodiments, the material mixture that is deposited may have a thermal conductivity ranging from about 1-200 W/mK. And in some embodiments, the material mixture that is deposited may have a thermal conductivity ranging from about 1-100 W/mK, from about 1-50 W/mK, from about 1-25 W/mK, from about 1-20 W/mK, or from about 1-10 W/mK. A component formed from compositions having higher thermal conductivity values may be capable of dissipating heat at a faster rate than components formed from compositions having relatively lower thermal conductivity values. When the component is a mold fabricated by a deposition process described above, the faster heat dissipation may allow for shorter processing times and increased throughput when producing tools or parts using the mold. In some embodiments, at least one of the powdered materials used may have a thermal conductivity ranging from about 1-8 W/mK. In some embodiments, at least one of the powdered materials used may have a thermal conductivity ranging from about 10 to 150 W/mK.

As described above, at least one binder or adhesive may be provided during manufacturing to bind the first layer and successive layers together to form the component geometry. For example, a binder may be a component of, coated onto, or mixed within the material being deposited prior to its deposition, such that the binder is deposited simultaneously with the material being deposited by the layering device, or a binder may be deposited separately from the remaining material being deposited. As described above, in some embodiments, a separate layer of binder or adhesive may be deposited after a layer of the material that will form the component is deposited. After building the component or mold geometry, one or more of the at least one binder may be removed from the component, for example, by heating or by chemical decomposition.

Suitable organic binders may be or include one or more waxes or resins that are insoluble, or at least substantially insoluble, in water. Waxes may include, for example, animal waxes, vegetable waxes, mineral waxes, synthetic waxes, or any combination thereof. Illustrative animal waxes may include, but are not limited to, bees wax, spermaceti, lanolin, shellac wax, or any combination thereof. Illustrative vegetable waxes may include, but are not limited to, carnauba, candelilla, or any combination thereof. Illustrative mineral waxes may include, but are not limited to, ceresin and petroleum waxes (e.g., paraffin wax). Illustrative synthetic waxes may include, but are not limited to, polyolefins (e.g., polyethylene), polyol ether-esters, chlorinated naphthalenes, hydrocarbon waxes, or any combination thereof. The organic binder may also include waxes that are insoluble in organic solvents. Illustrative waxes that are insoluble in organic solvents may include, but are not limited to, polyglycol, polyethylene glycol, hydroxyethylcellulose, tapioca starch, carboxymethylcellulose, or any combination thereof. Illustrative organic binders may also include, but are not limited to, starches, and cellulose, or any combination thereof. The organic binders may also include, but are not limited to, microwaxes or microcrystalline waxes. Microwaxes may include waxes produced by de-oiling petrolatum, which may contain a higher percentage of isoparaffinic and naphthenic hydrocarbons as compared to paraffin waxes. Other suitable binders may include, for example, sodium silicate, acrylic copolymers, arabic gum, portland cement and the like. Binders may be deposited in solid or liquid form.

Selected material mixtures may be deposited to form different regions of a component, depending on, for example, the type of component being made and the desired properties of the component. For example, according to some embodiments, one or more layers being deposited to form a component may include a first material mixture and a second material mixture, where the first material mixture and the second material mixture are different and form distinct regions of the one or more layers. The distinct regions may provide desired properties to different parts of the component. For example, when the component is a mold manufactured according to embodiments presented herein, it may be formed to include a region having relatively higher thermal insulation properties, a region having a relatively higher coefficient of friction, and/or an electrically conductive region. Whereas a mold having regions of different material properties would have otherwise been manufactured by assembling separate pieces together or by performing subsequent material treatments, distinct regions of a mold according to embodiments of the present disclosure may be formed using a single additive manufacturing process disclosed herein, thereby allowing the mold to be formed as a single structure having at least one distinct region of material with a different material property than the remaining region(s) of the component. In another example, a mold for a component in which it is desirable for the component to have a controlled surface finish, such as the pocket or hole to which a cutting element is subsequently brazed. For example, the mold (or components) may have surface asperities ranging from about 20 to about 400 microns in some embodiments, or less than 200, 100 or 50 microns in some embodiments. In some embodiments, a certain region of the mold or component (e.g., those corresponding to the pocket) may have a high surface finish (e.g., surface asperities of from 20 to 400 microns), and other regions of the mold or component may have a lower surface finish (e.g., surface asperities greater than that in the first region).

In one or more embodiments, gradients of different types of materials may be formed in the component, for example, by depositing varying ratios of constituents of a material mixture, or by depositing a material mixture with similar composition but varying particle sizes, layer by layer to build the geometry of the component. In some embodiments, a layering device may have multiple nozzles, where each nozzle deposits a different constituent of a material mixture or different particle sizes of a material at a changing rate to form one or more layers of the component geometry. For example, in some embodiments, a constituent of a material mixture may be deposited throughout a layer by a nozzle of a layering device in gradually changing amounts, while one or more other nozzles of the layering device may deposit other constituents of the material mixture in varying amounts, thereby creating a material mixture layer with a gradually changing ratio of constituents. The amount of a first constituent deposited relative to remaining constituents of a material mixture may range from depositing 100% of the first constituent and 0% of the remaining constituents to form part of a layer to depositing 0% of the first constituent and 100% of the remaining constituents to form part of the layer, including any ratio therebetween. In some embodiments, the entire component may possess a gradient composition, while in other embodiments only a portion of the component may possess a gradient composition. In other embodiments, a layering device having more than one nozzle may be used to deposit a single layer with varying particle sizes throughout the single layer, where one nozzle may deposit a material having one range of particle size and another nozzle may deposit a material having a different range of particle size. Particle size ranges for materials deposited by layering devices may depend, for example, on the type of material being deposited, the region of the component being formed, the type of layering device used, and the amount of porosity desired in the component design, but may range from nano-sized, micro-sized and larger, as described above.

As shown in FIG. 2, a component design 10 generated with a CAD system 12 is transferred to a layering device 14 which may then begin to construct a mold for the component design 10 by dividing the solid model using horizontal planes 16 into thin cross-sectional, two dimensional, layers revealing a cross-sectional outer mold line 18 of the desired component shape. Based on the beginning cross sectional layer, the layering device 14 may then deposit a thin layer of mold material 20 on a platform or substrate. The mold material may be any of the material mixtures or combinations of materials previously described. A spray head may then be used to spray adhesive in those regions of the layer of material where the mold is to be formed, forming a mold having the traced inner mold line 22. Another layer of mold material may then be laid on top of the formed mold layer based upon the next cross sectional layer and the process may be repeated until a mold 24 is built. As shown, the mold 24 may be formed with an opening 25 which allows for the deposition of the material that will become the design 10 or component generated with the CAD system 12. In some embodiments, the CAD system may be used to directly generate a mold design based upon the design of a component and this mold design may then be deposited layer by layer according to any of the methods previously discussed. In some embodiments, the design of a component generated with a CAD system may be used to directly from the component by depositing a material mixture layer by layer according to any of the methods previously described.

In some embodiments, the material mixture used to form the bulk of the component may be coated with an adhesive or binder. In these embodiments, the a heat source (e.g., a laser) may be used to fuse the coating or the binder by heating the material mixture to the melting temperature of the coating or binder, which may be lower than the melting temperature of the material mixture used to form the bulk of the component, thereby fusing the coating or binder. The heat source may be configured to heat the portions of the material mixture that will form the mold or component. This may result in the bonding of the material mixture used to form the bulk of the component, as well as the bonding of adjacent layers resulting in a “green” state component.

A green state component may be easier to machine which can improve precise tolerances in dimensionally sensitive areas. The consistency of the green state component can be controlled by varying the coating or binder, the infiltrant, or the material mixture used or by controlling the temperature to which the coating or binder is exposed. Upon completing any desired machining or other processing, the green state component may be fully cured to create the final component by any means known in the art.

In other embodiments, the layering device 14 precisely lays a material layer defining a mold cross-sectional shape having an inner mold line 22 equivalent to the outer component line 18 of a corresponding CAD solid model layer of a component to be formed by the mold. The layering device 14 precisely lays mold material mixture 20 constructing a layer with a thickness equal to that of a corresponding CAD solid model layer of the component wherein the layer has an inner mold line 22 equivalent to the corresponding CAD layer outer component line 18. In these embodiments, the mold material mixture may be any of the materials or combinations thereof previously discussed, coated with a resin or a binder. As each layer is laid, the layer is subjected to the melting temperature of the coating or binder, fusing the coating or binder, and bonding the layer of mold material mixture together as well as with the other layers to form a green state mold. As with the previous embodiments, the mold material layers may also be sintered to construct a mold in its final cured state.

When a mold is made using the above described methods, the entire mold (for the desired component) may be made, or a portion of the mold may be made and modularly connected to other mold portions. For example, in manufacturing drag bits, generally, the portion of the blades holding the cutters are a more variable portion of the bit. As such, the bottom section of the mold corresponding to this portion of the drill bit would be formed specifically for each drill bit design. However, many bits include intermediate sections and top sections that have similarities with other bits. For example, a six bladed bit of a given size may have a similar geometry to other six bladed bits of the same size at portions of the blade that do not carry cutters (e.g., the gage). In addition, the top portion of the drill bit may be very similar for similar sized bits. As such, the intermediate and upper portions could be used in multiple bit designs. As such, these portions of the mold may be reused.

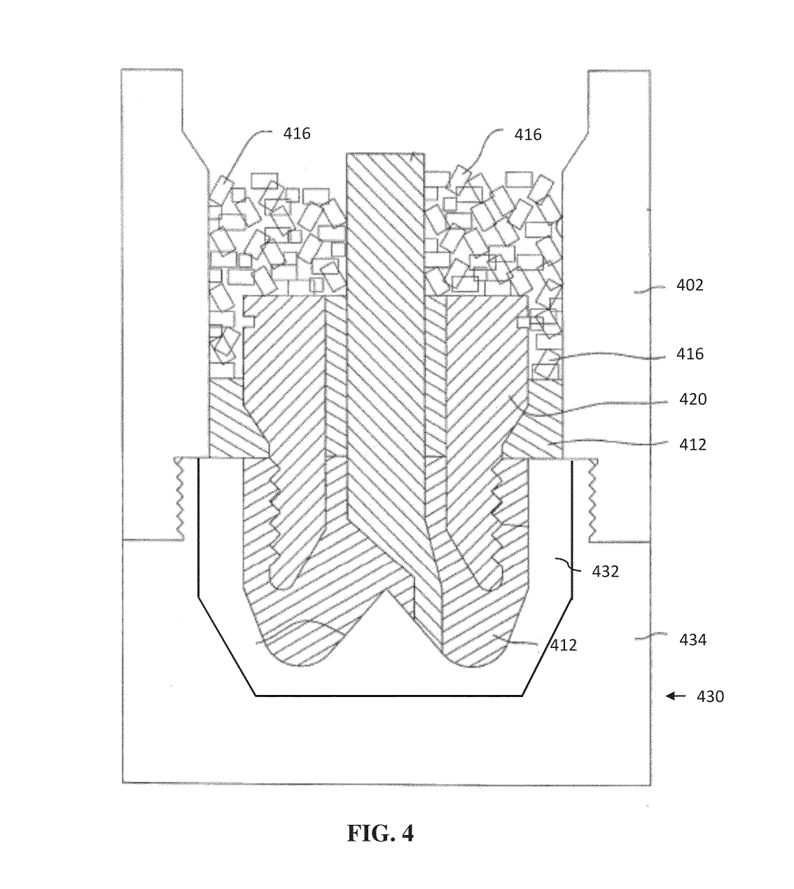

FIG. 4 shows a cross sectional view of a mold assembly according to embodiments of the present disclosure. The mold assembly includes a bottom mold portion 430 having the general negative shape of a downhole cutting tool body. The bottom mold portion may include an inner mold portion 432, generally corresponding to the negative shape of the tool body, and an outer portion 434 or sleeve that is shaped to mate with an outer surface of the inner mold portion 432. The inner mold portion 432 may be formed for each specific bit design, while the outer portion 434 may be reused for multiple molds. The inner mold may have a thickness in the range of about 0.25 inches to about 12 inches, about 0.5 inches to about 2 inches, or about 0.5 inches to about 1 inch. In some embodiments, the inner mold may have a minimum thickness of about 0.25 inches, about 0.5 inches As shown, the inner mold portion 432 may have an angular bottom, however, any suitable shape may be used, and, e.g., the inner mold portion 432 may have a rounded shape. The outer mold portion 434 may be made of any suitable material, and e.g., could be a graphite block machined to correspond to the outer surface of the inner mold portion. The outer mold portion 434 may be reused. While this embodiment shows separate bottom mold portions, a single bottom mold portion may also be used. In addition, multiple inner and/or outer portions may also be used. A funnel ring 402 is fitted over the bottom mold portion 430.

In some embodiments, the contents 410 include a starting powder 412 loaded around a steel blank 420 and an infiltrant 416. The starting powder 412 may be any suitable material, e.g., a carbide such as tungsten carbide. The infiltrant 416 (e.g., a metal binder such as a copper based binder) may be loaded (e.g., as a powder or in precut chunks) over the starting powder 412, and flux material may be poured over the infiltrant and/or coated on the infiltrant. The contents within the mold may then be heated to the flow or infiltration temperature of the infiltrant 416 so that the melted infiltrant material infiltrates the starting material 412 within the mold 430 and bonds particles of the starting material to each other and to any other components (e.g., a steel blank 420) to form a solid cutting tool body.

Components which may be formed by using molds according to embodiments presented in this disclosure include any downhole tools or components for downhole tools, for example, earth boring bits such as PDC drag bits, diamond impregnated bits, roller cone bits, or percussion bits; mills; reamers; reamer blocks; motors; stabilizers; or any other downhole tool or component of a downhole tool. For instance, in one or more embodiments, a mold made by the methods of the present disclosure may include a mold for a PDC bit or a portion of a PDC bit. Such mold may include mold features corresponding to a plurality of blades extending from a bit body, and a plurality of cutter pockets on the plurality of blades. While cutter pockets are conventionally milled into blades after the bit is formed or are formed using displacements having a high surface finish, the molds formed by the present disclosure may form cutter pockets during the bit formation. Thus, when bit materials are poured into the mold and heated, cutter pockets may be formed during this process instead of subsequently or requiring the use of a displacement. While aspects of the present application have described use of the disclosure in downhole tools, molds and components may also be formed for any suitable purpose.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

Further, it should be understood that any directions or reference frames in the preceding description are merely relative directions or movements. For example, any references to “up” and “down” or “above” or “below” are merely descriptive of the relative position or movement of the related elements.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

What is claimed:

1. A method of forming a mold used to manufacture downhole tools, comprising:
depositing successive layers of a material mixture and an adhesive using an automated layering device according to a computer aided pattern, the material mixture comprising a first composition and a second composition, the first composition having at least a different shape, size, or chemical composition than the second composition, at least one of the first composition or the second composition being granulated.

2. The method of claim 1, wherein the first composition and the second composition are granulated together.

3. The method of claim 2, wherein the granulated first composition or second composition has a diameter from about 1 μm to about 200 μm.

4. The method of claim 1, wherein the material mixture has a thermal conductivity ranging from about 1-200 W/mK.

5. The method of claim 1, wherein the first composition and the second composition are independently selected from the group consisting of amorphous carbon, graphite, metal oxide, metal carbide, metal boride, metal nitride, and combinations thereof.

6. The method of claim 1, wherein the first composition and the second composition are independently selected from the group consisting of silicon dioxide, zirconium silicate, silicon carbide, aluminum nitride, amorphous carbon, graphite, and combinations thereof.

7. The method of claim 1, wherein the second composition is coated on the first composition.

8. The method of claim 7, wherein the particles of the second composition are smaller than the particles of the first composition.

9. The method of claim 1, wherein at least one of the first composition and the second composition has a thermal conductivity ranging from 1-8 W/mK.

10. The method of claim 1, further comprising binding a portion of the successive layers of the material mixture together with the adhesive.

11. The method of claim 1, wherein the material mixture is varied during at least a portion of the deposition of the successive layers to generate a component where at least a portion of the component has a gradient composition.

12. A method of forming components used in downhole tools using a mold, comprising:
depositing successive layers of a material composition comprising a granulated powder using an automated layering device based on a computer aided design;
binding a portion of the successive layers of the material composition together to form the mold; and
forming the component using the mold.

13. The method of claim 12, wherein the granulated powder has a diameter from about 1 μm to about 200 μm.

14. The method of claim 12, wherein the granulated powder has a thermal conductivity ranging from about 1-200 W/mK.

15. The method of claim 12, wherein the granulated powder comprises a mixture of at least two powdered materials.

16. The method of claim 15, wherein the first composition and the second composition are independently selected from the group consisting of amorphous carbon, graphite, metal oxide, metal carbide, metal boride, metal nitride, and combinations thereof.

17. The method of claim 15, wherein the first composition and the second composition are independently selected from the group consisting of silicon dioxide, zirconium silicate, silicon carbide, aluminum nitride, amorphous carbon, graphite, and combinations thereof.

18. The method of claim 12, further comprising coating the granulated powder with a binder material prior to deposition.

19. A mold used to manufacture downhole tools, comprising:
a material mixture and an adhesive formed using an automated layering device according to a computer aided pattern, the material mixture comprising a first composition and a second composition, the first composition having at least a different shape, size, or chemical composition than the second composition, at least one of the first composition or the second composition being granulated.

20. The mold of claim 19, wherein the material mixture comprises a granulated particle comprising amorphous carbon or graphite granulated with silicon dioxide, zirconium silicate, silicon carbide, or aluminum nitride, and the granulated particle has a diameter from about 1 μm to about 200 μm.
